(19) United States
(12) Patent Application Publication
(10) Pub. No.: US 2018/0276635 A1
(43) Pub. Date: Sep. 27, 2018

(54) ELECTRONIC APPARATUS, SALES DATA PROCESSING APPARATUS, AND CASH REGISTER

(71) Applicant: CASIO COMPUTER CO., LTD., Tokyo (JP)

(72) Inventor: Katsuyuki ITAKURA, Tokyo (JP)

(73) Assignee: CASIO COMPUTER CO., LTD., Tokyo (JP)

(21) Appl. No.: 15/887,487

(22) Filed: Feb. 2, 2018

(30) Foreign Application Priority Data
Mar. 23, 2017 (JP) 2017-056769

(51) Int. Cl. G06Q 20/20; G07G 1/00; G07G 1/12; H04B 1/3827

(52) U.S. Cl. CPC G06Q 20/206; G07G 1/0009; H04B 1/3827; G07G 1/12; G07G 1/0018

(57) ABSTRACT

An electronic apparatus includes a communication unit configured to perform wireless communication with a portable terminal and a mode switching unit configured such that a key inserted into the mode switching unit is rotatable and configured to perform switching to a mode corresponding to a rotation position of the inserted key. The mode switching unit has a plurality of first rotation positions for performing switching to a first mode of performing switching to a state where the communication unit can perform communication with the portable terminal and at least one second rotation position for performing switching to a second mode of performing switching to a state where the communication unit cannot perform communication with the portable terminal. The second rotation position is not interposed between the first rotation positions.

### CROSS-REFERENCE TO RELATED APPLICATION

This application claims priority from Japanese Patent Application No. 2017-056769 filed on Mar. 23, 2017, the entire subject matter of which is incorporated herein by reference.

### BACKGROUND

### Technical Field

The present disclosure relates to an electronic apparatus, a sales data processing apparatus, and a cash register.

### Description of Related Art

In the related art, electronic apparatuses which can be installed in stores selling goods and be used to register sales data such as the prices, numbers, and the like of goods sold to customers, such as an electronic cash register (ECR), are known.

Such an electronic apparatus has a configuration having a communication unit configured to establish wireless communication with a portable terminal such as a smart phone such that information exchange is possible (see Japanese Patent Application Laid-Open No. 2002-63652 and Japanese Patent Application Laid-Open No. 2004-185492 for instance).

By the way, the electronic apparatus of the related art has various modes such as a setting mode of setting the unit prices of goods, a menu, and so on, a registration mode of performing registration of sales, and an adjustment mode of performing adjustment of sales, and an operator (a salesclerk) or an owner switches the electronic apparatus to a desired mode for a purpose and operates the electronic apparatus.

Also, the electronic apparatus of the related art has a drawer for storing cash and the like, and has a configuration in which, from the perspective of security, it is possible to perform a mode switching operation by inserting a mode key into a predetermined keyhole and rotating the mode key to a certain position.

By the way, the modes of the electronic apparatus of the related art consist of modes of turning on the power of the communication unit so as to perform wireless communication with the portable terminal and modes of turning off the power of the communication unit so as not to perform wireless communication with the portable terminal.

However, in the electronic apparatus of the related art, the arrangement of the individual modes does not correspond to the ON/OFF state of the power of the communication unit. For example, in the case of switching the electronic apparatus from a mode of turning on the power of the communication unit to another mode of turning on the power of the communication unit, if a mode of turning off the power of the communication unit is between both modes, although it should not be necessary to turn off the power of the communication unit, it is necessary to turn off the power of the communication unit once and then turn on the power again. Therefore, there is a problem that the process is complicated and the power consumption increases.

### SUMMARY

In order to solve the above-mentioned problem, an electronic apparatus of the present disclosure includes a communication unit configured to perform wireless communication with a portable terminal and a mode switching unit configured such that a key inserted into the mode switching unit is rotatable and configured to perform switching to a mode corresponding to a rotation position of the inserted key. The mode switching unit has a plurality of first rotation positions for performing switching to a first mode of performing switching to a state where the communication unit can perform communication with the portable terminal and at least one second rotation position for performing switching to a second mode of performing switching to a state where the communication unit cannot perform communication with the portable terminal. The second rotation position is not interposed between the first rotation positions.

### BRIEF DESCRIPTION OF THE DRAWINGS

If the following description is considered in conjunction with the following drawings, it is possible to more deeply understand this application.

FIG. 1 is a connection diagram illustrating an outline of configuration of a sales data processing system according to an embodiment.

FIG. 2 is a block diagram illustrating a main control configuration of a portable terminal.

FIG. 3 is a block diagram illustrating a main control configuration of a sales data processing apparatus.

FIGS. 4A and 4B are appearance diagrams illustrating an outline of configuration of the sales data processing apparatus.

FIG. 5 is a plan view illustrating the configuration of a mode switch.

FIGS. 6A and 6B are views illustrating the configurations of mode keys.

FIG. 7 is a view illustrating operations of individual modes of the sales data processing apparatus.

### DETAILED DESCRIPTION

Hereinafter, an embodiment of the present disclosure will be described in detail with reference to the accompanying drawings.

[1. Description of Configuration]

[1-1. Description of System Configuration]

The configuration of a sales data processing system 1 according to the present embodiment will be described.

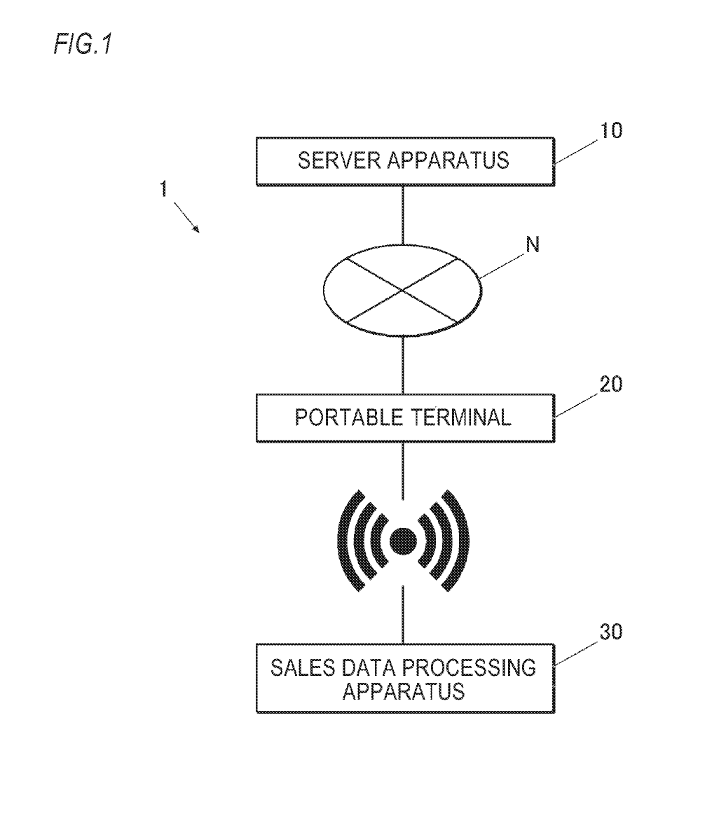

As shown in FIG. 1, the sales data processing system 1 is configured with a server apparatus 10, at least one portable terminal 20, and at least one sales data processing apparatus 30. The server apparatus 10 and each portable terminal 20 are connected to a communication network N. As the communication network N, the Internet is used; however, any other network such as a local area network (LAN) may be used. Also, each portable terminal 20 and each sales data processing apparatus 30 perform narrow-area wireless communication such as Bluetooth (registered as a trade mark) or wide-area wireless communication such as Wi-Fi (registered as a trade mark).

The server apparatus 10 is a server apparatus on a cloud, and manages a variety of data such as sales data of goods transmitted from the at least sales data processing apparatus 30 via the at least portable terminal 20.

Each portable terminal 20 is a portable terminal device such as a smart phone, and transmits a variety of data such as sales data of goods transmitted from each sales data processing apparatus 30 to the server apparatus 10. In each portable terminal 20, various applications (for example, a setting application, an order entry application (a registration application), and an adjustment application) for implementing the functions of predetermined modes (for example, a setting mode, a registration mode, and an adjustment mode) of each sales data processing apparatus 30 by wireless communication with the corresponding sales data processing apparatus 30 are installed.

Each sales data processing apparatus 30 is an ECR or the like which can be installed in a store such as a private store, a supermarket, or a grocery, and is an apparatus which an operator can operate to register sales data such as the prices, numbers, and the like of goods sold or provided to customers. In one store, at least one sales data processing apparatus 30 is installed. The server apparatus 10 can manage sales data of a plurality of stores in an integrated fashion.

[1-2. Description of Configuration of Portable Terminal]

Now, the configuration of a portable terminal 20 will be described.

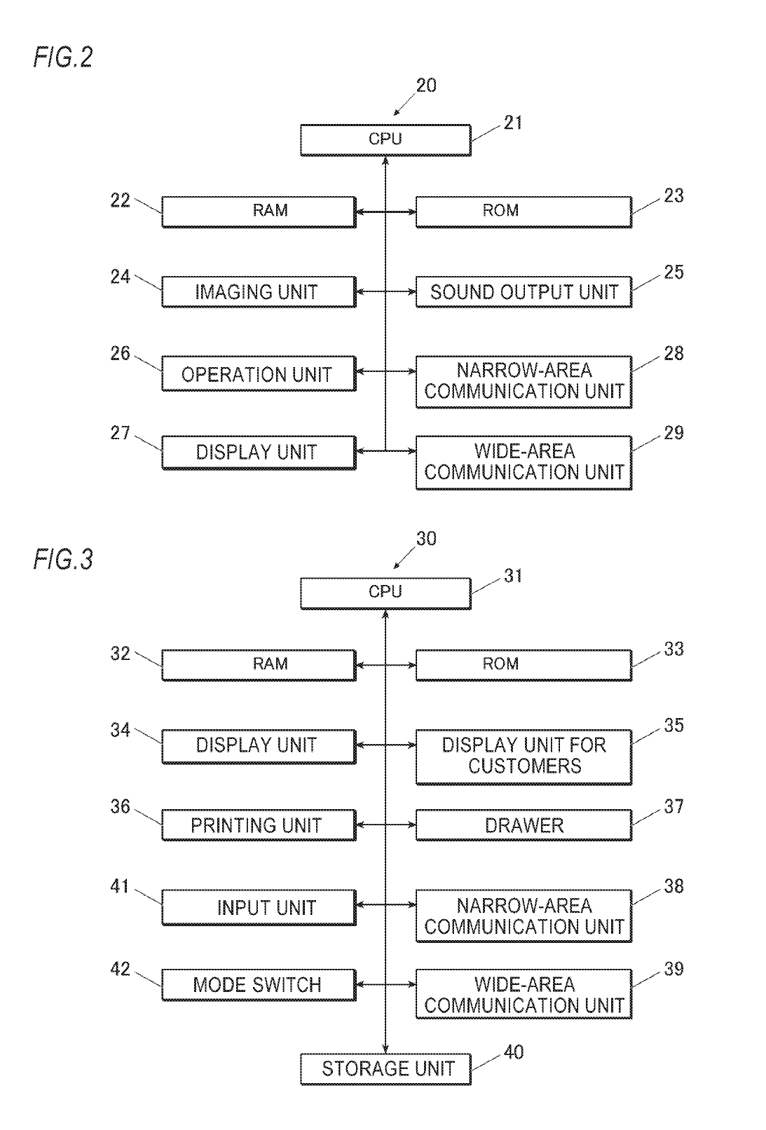

As shown in FIG. 2, the portable terminal 20 is configured to include a CPU 21, a RAM 22, a ROM 23, an imaging unit 24, a sound output unit 25, an operation unit 26, a display unit 27, a narrow-area communication unit 28, and a wide-area communication unit 29.

The CPU 21 controls the individual units of the portable terminal 20. The CPU 21 reads out programs designated from various programs, from the ROM 23, and develops the read programs in the RAM 22, and performs various processes in cooperation with the developed programs.

The RAM 22 is, for example, a volatile semiconductor memory, and has a work area for storing a variety of data and programs.

The ROM 23 is a read-only memory for storing a variety of data and various programs. The ROM 23 is for storing a system program, various application programs such as a setting application, a registration application, and an adjustment application, and a Web browser executable by the CPU 21, data required to execute these programs, and so on.

The imaging unit 24 images subjects according to user's operations, thereby generating image data.

The sound output unit 25 is configured with a D/A converter, an amplifier, a speaker, and so on, and converts sound data output from the RAM 22 or the ROM 23 into analog sound signals, and outputs sounds.

The operation unit 26 includes, for example, a key input unit composed of a home button and so on, and a touch panel formed integrally with the display unit 27, and receives operation inputs from a user, and outputs operation signals according to the operation inputs to the CPU 21.

The display unit 27 includes a display such as a liquid crystal display (LCD) or an flat panel display (FPD) using organic EL (Electro Luminescence) elements, and displays images based on display control signals output from the CPU 21, on a display screen.

The narrow-area communication unit 28 is configured with an antenna, a demodulating circuit, a signal processing circuit, and so on, and performs narrow-area wireless communication with the sales data processing apparatus 30 by a wireless communication method such as Bluetooth (registered as a trade mark).

The wide-area communication unit 29 is configured with an antenna, a demodulating circuit, a signal processing circuit, and so on, and performs wide-area wireless communication with a sales data processing apparatus 30 by a wireless communication method such as Wi-Fi (registered as a trade mark).

[1-3. Description of Configuration of Sales Data Processing Apparatus]

Now, the configuration of a sales data processing apparatus 30 will be described.

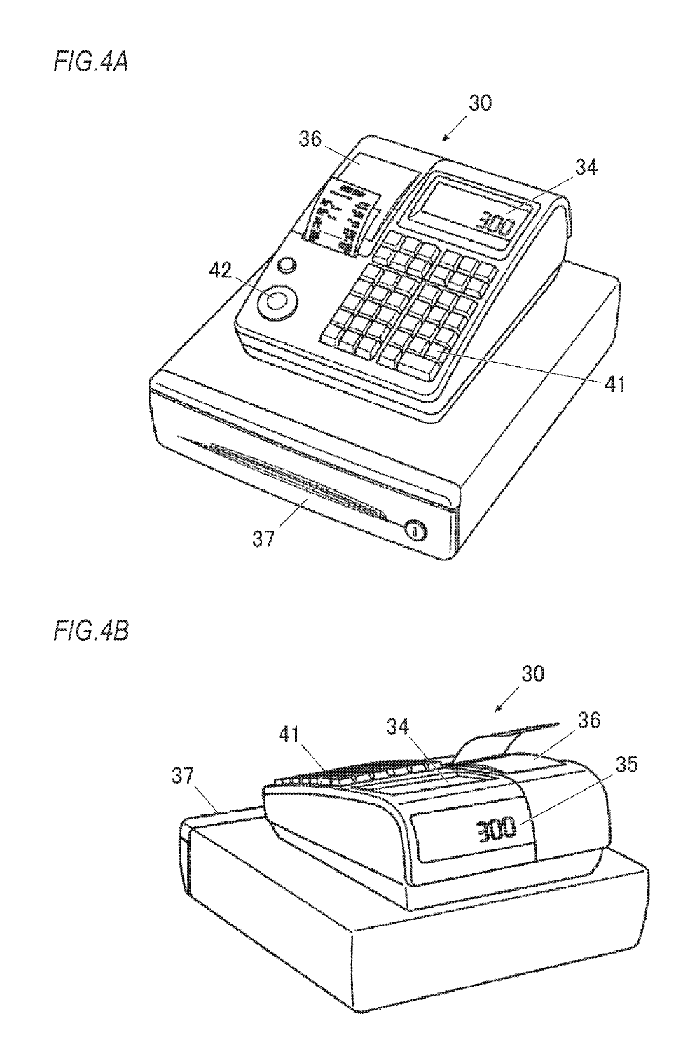

As shown in FIGS. 3 and 4, the sales data processing apparatus 30 is configured to include a CPU 31, a RAM 32, a ROM 33, a display unit 34, a display unit 35 for customers, a printing unit 36, a drawer 37, a narrow-area communication unit 38, a wide-area communication unit 39, a storage unit 40, an input unit 41, and a mode switch 42.

The CPU 31 controls the individual units of the sales data processing apparatus 30. The CPU 31 reads out programs designated from various programs, from the ROM 33, and develops the read programs in the RAM 32, and performs various processes in cooperation with the developed programs.

The RAM 32 is, for example, a volatile semiconductor memory, and has a work area for storing a variety of data and programs.

The ROM 33 is a read-only memory for storing a variety of data and various programs.

The display unit 34 is a display device configured such that the an operator or an owner operating the sales data processing apparatus 30 can recognize display contents (information such as the prices, total prices, and the like of goods) as shown in FIG. 4A. The display unit 34 includes a display such as an LCD or an EL device, and displays images based on display control signals output from the CPU 31, on a display screen.

The display unit 35 for customers is a display device configured such that customers purchasing goods can recognize display contents (information such as the prices, total prices, and the like of goods) as shown in FIG. 4B. The display unit 35 for customers includes a display such as an LCD or an EL device, and displays images based on display control signals output from the CPU 31, on a display screen.

The printing unit 36 is a printing unit such as a thermal printer configured to print data such as receipts and electronic journals on paper such as a roll of paper under control of the CPU 31. Also, the printing unit 36 has a mechanism for cutting a printed part from a roll of paper and discharging the printed part.

The drawer 37 is a drawer for storing cash, gift certificates, and so on. The drawer 37 is opened under control of the CPU 31, for example, during closing of registration of goods (adjustment).

The narrow-area communication unit 38 is configured with an antenna, a demodulating circuit, a signal processing circuit, and so on, and performs narrow-area wireless communication with the portable terminal 20 by a wireless communication method such as Bluetooth (registered as a trade mark).

The wide-area communication unit 39 is configured with an antenna, a demodulating circuit, a signal processing circuit, and so on, and performs wide-area wireless communication with a portable terminal 20 by a wireless communication method such as Wi-Fi (registered as a trade mark).

The narrow-area communication unit 38 and the wide-area communication unit 39 function as a communication unit of the present disclosure.

The storage unit 40 is a storage unit for writing and reading information, and is configured with a battery-backed RAM, a flash memory, and the like. In the storage unit 40, sales data, a variety of setting information, and so on are stored.

The input unit 41 includes a keyboard having various function keys, and receives inputs according to operator's operations of pushing the keys, and outputs the operation information to the CPU 31. Examples of the function keys include not only numeric keys, a multiplication key, a subtotal key, a return key, and a PLU (Price Look Up) key but also various closing keys such as a coupon sale key and a credit sale key.

The mode switch 42 is a switch for switching the mode of the sales data processing apparatus 30 to one of a setting mode, a return mode, an OFF mode, a registration mode, a calculator mode, a check mode, and an adjustment mode.

The setting mode is a mode of configuring various settings (such as settings for the unit prices of goods) of the sales data processing apparatus 30. The return mode is a mode of performing a process of returning goods. The OFF mode is a mode of turning off the power of the sales data processing apparatus 30. The registration mode is a mode of performing a process of registering sales data on sold goods. The calculator mode is a mode of performing calculation similarly to a normal calculator. The check mode is a mode of performing a process of checking registered sales data. The adjustment mode is a mode of performing a process of adjusting the sales of one day after closing the store.

Out of the modes of the sales data processing apparatus 30, the setting mode, the registration mode, and the adjustment mode are modes of turning on the power of the communication unit (the narrow-area communication unit 38 or the wide-area communication unit 39) and performing wireless communication with a portable terminal 20. More specifically, the registration mode is a mode of turning on the power of the wide-area communication unit 39 and performing wide-area wireless communication with a portable terminal 20, and the setting mode and the adjustment mode are modes of turning on the power of the narrow-area communication unit 38 and performing narrow-area wireless communication with a portable terminal 20. Here, the reason why the registration mode performs wide-area wireless communication with a portable terminal 20 is that when taking an order from a portable terminal 20, it is possible to easily take an order of a customer far from the sales data processing apparatus 30. Also, the reason why the setting mode performs narrow-area wireless communication with a portable terminal 20 is that while performing a registering process in the registration mode, the operator does not want to use the same wireless communication (wide-area wireless communication) to perform communication (for example, transmission of setting data). Also, the reason why the adjustment mode performs narrow-area wireless communication with a portable terminal 20 is that it is required to open the drawer 37 in order to perform an adjusting process.

Meanwhile, the remaining modes, i.e. the return mode, the OFF mode, the calculator mode, and the check mode are modes of turning off the power of the communication unit so as not to perform wireless communication with any portable terminal 20.

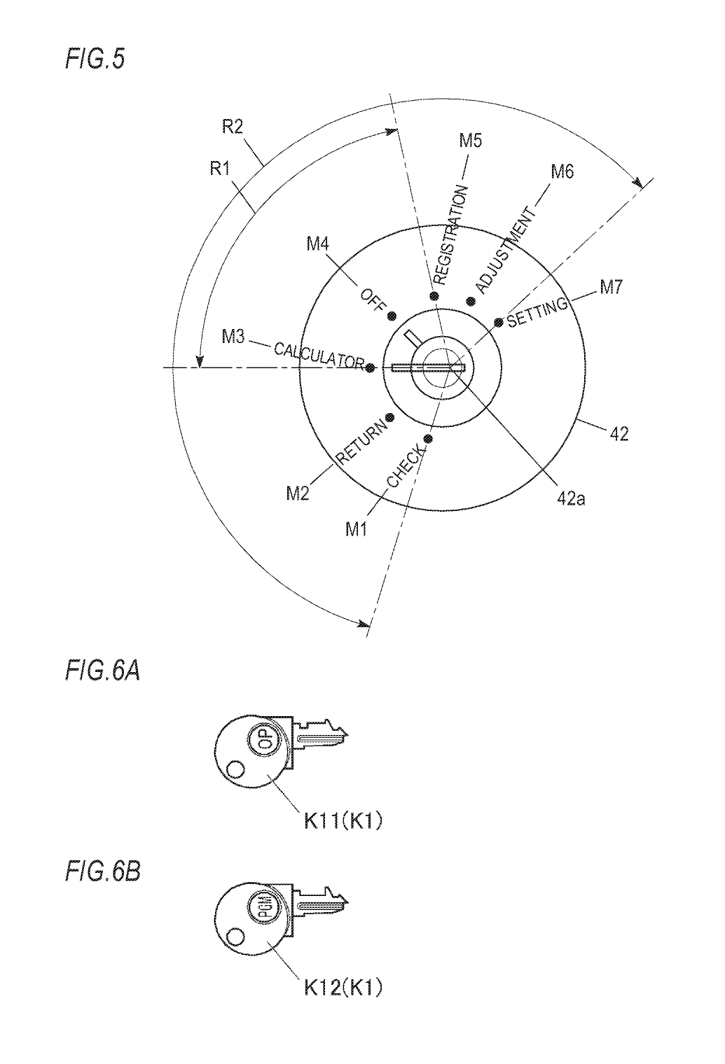

The mode switch 42 has a keyhole 42a for inserting mode keys K1 (see FIGS. 6A and 6B) as shown in FIG. 5, and the operator can insert a mode key K1 into the keyhole 42a and rotate the mode key K1 to a certain position, thereby performing an operation of switching the sales data processing apparatus to a mode corresponding to the position of the mode key. In other words, the mode switch 42 is configured such that it is possible to insert mode keys K1 therein and rotate the mode keys, and functions as a mode switching unit of the present disclosure for performing switching to a mode corresponding to a rotation position of a mode key K1 if the corresponding key is inserted into the mode switching unit and is rotated to the corresponding rotation position.

As the mode keys K1, two types of keys, i.e. an operator key K11 (see FIG. 6A) for the operator and an owner key K12 (see FIG. 6B) for the owner can be used.

The mode switch 42 is configured such that the mode keys K1 can be inserted and then be rotated in ranges different depending on the types of the mode keys K1. For example, the mode switch 42 is configured such that a range in which the operator key K11 can be rotated in a state where it is inserted is narrower than a range in which the owner key K12 can be rotated in a state where it is inserted.

Specifically, the operator key K11 can be used to perform switching to the OFF mode, the registration mode, and the calculator mode of the modes of the sales data processing apparatus 30. In other words, the operator can perform the OFF mode, the registration mode, and the calculator mode of the modes of the sales data processing apparatus 30.

Meanwhile, the owner key K12 can perform switching to every mode of the sales data processing apparatus 30. In other words, the owner can perform every mode of the sales data processing apparatus 30.

In FIG. 5, a reference symbol R1 represents the rotatable range of the operator key K11, and a reference symbol R2 represents the rotatable range of the owner key K12. In the example shown in FIG. 5, the rotatable range R1 of the operator key K11 is set to be positioned inside the rotatable range R2 of the owner key K12.

As shown in FIG. 5, on the mode switch 42, rotation positions for switching to the check mode M1, the return mode M2, the calculator mode M3, the OFF mode M4, the registration mode M5, the adjustment mode M6, and the setting mode M7 are arranged in the order of them in the clockwise direction.

Also, the mode switch 42 is configured such that it is possible to insert a mode key K1 only at the position of the OFF mode M4 and it is impossible to pull out that mode key K1 at a position other than the OFF mode M4, i.e. the position of the check mode M1, the position of the return mode M2, the position of the calculator mode M3, the position of the registration mode M5, the position of the adjustment mode M6, or the position of the setting mode M7. This is the true not only for the operator key K11 but also for the owner key K12.

Hereinafter, for ease of explanation, the rotation positions for switching to the modes will also be referred to simply as the modes.

In the present embodiment, the operator key K11 can be used to perform switching to three modes (the calculator mode M3, the OFF mode M4, and the registration mode M5), which are arranged to be contiguous. Therefore, it is possible to perform mode switching operations using the operator key K11, without any problem.

Also, in the present embodiment, the mode switch has the rotation positions (first rotation positions) for switching the sales data processing apparatus to the modes of turning on the power of the communication unit and performing wireless communication with a portable terminal 20 (first mode, i.e. the registration mode M5, the adjustment mode M6, and the setting mode M7), and the rotation positions (second rotation positions) for switching the sales data processing apparatus to the modes of turning off the power of the communication unit so as not to perform wireless communication with any portable terminal 20 (second mode, i.e. the check mode M1, the return mode M2, the calculator mode M3, and the OFF mode M4), and the second rotation positions are set so as not to be interposed between the first rotation positions. Therefore, for example, in the case of switching the sales data processing apparatus from a mode of turning on the power of the communication unit to another mode of turning on the power of the communication unit, since a mode of turning off the power of the communication unit is not between both modes, it is possible to perform a mode switching operation without unnecessarily turning on and off the power of the communication unit.

Also, in the present embodiment, the rotation positions (third rotation positions) for switching the sales data processing apparatus to the modes of turning on the power of the narrow-area communication unit 38 and performing narrow-area wireless communication with a portable terminal 20 (third mode, i.e. the adjustment mode M6 and the setting mode M7), and the rotation position (a fourth rotation position) for switching the sales data processing apparatus to the mode of turning on the wide-area communication unit 39 and performing wide-area wireless communication with the portable terminal 20 (a fourth mode, i.e. the registration mode M5) are arranged such that the fourth rotation position is not interposed between the third rotation positions. Therefore, for example, in the case of switching the sales data processing apparatus from a mode of turning on the power of the narrow-area communication unit 38 to another mode of turning on the power of the narrow-area communication unit 38, since the mode of turning on the power of the wide-area communication unit 39 is not between both modes, it is possible to perform a mode switching operation without unnecessarily turning on and off the power of the wide-area communication unit 39.

[2. Description of Operations]

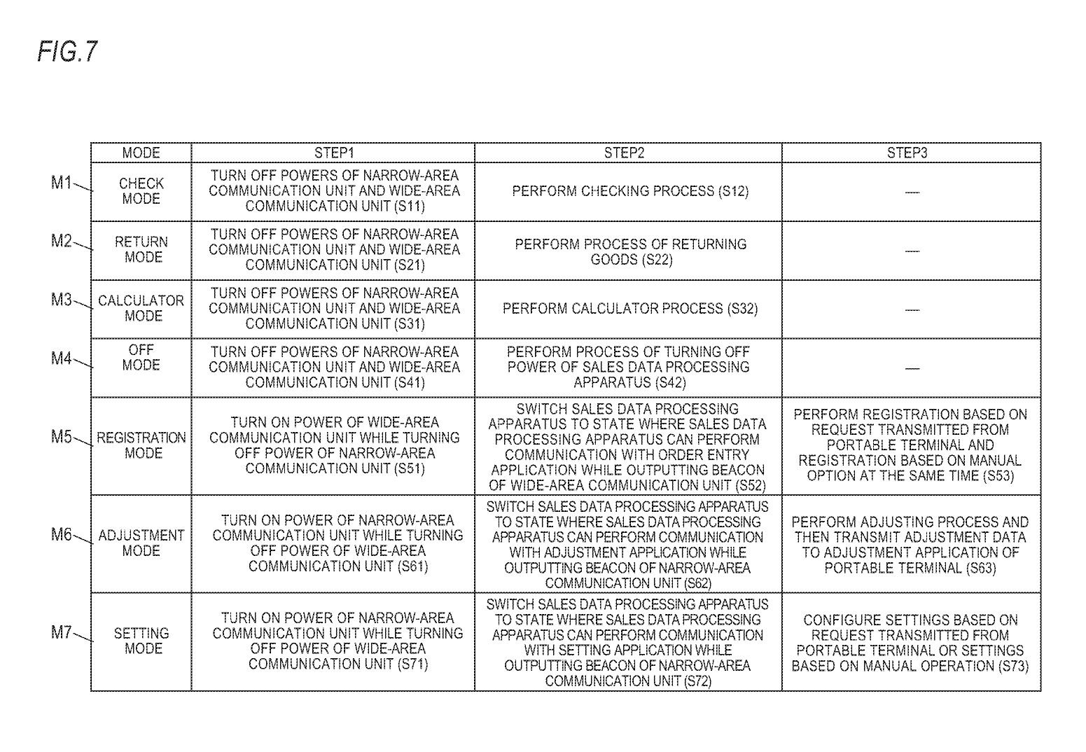

Now, operations of the individual modes of the sales data processing apparatus 30 according to the present embodiment will be described in brief with reference to FIG. 7. In FIG. 7, the operator key K11 can be used to switch the sales data processing apparatus to the calculator mode M3, the OFF mode M4, or the registration mode M5, and the owner key K12 can be used to switch the sales data processing apparatus to every mode (the check mode M1, the return mode M2, the calculator mode M3, the OFF mode M4, the registration mode M5, the adjustment mode M6, and the setting mode M7). The operator or the owner can switch the sales data processing apparatus to a desired mode with the operator key K11 or the owner key K12, thereby performing the corresponding mode.

[2-1. Description of Modes of Turning Off Power of Communication Unit]

All of the check mode M1, the return mode M2, the calculator mode M3, and the OFF mode M4 are modes of turning off the power of the communication unit so as not to perform wireless communication with any portable terminal 20.

Therefore, first, the CPU 31 performs a process of turning off the power of the communication unit (the narrow-area communication unit 38 and the wide-area communication unit 39) (STEPS S11, S21, S31, or S41). In the case where the power of the communication unit has been already turned off, the CPU proceeds to the next step without performing anything in particular.

Next, the CPU 31 performs a process corresponding to each mode on the basis of an operation of the operator or the owner. For example, in the check mode M1, the CPU performs a process of checking registered sales data on the basis of an operation of the owner (STEP S12). Also, in the return mode M2, the CPU performs a process of returning goods on the basis of an operation of the owner (STEP S22). Also, in the calculator mode M3, the CPU performs a calculator process on the basis of an operation of the operator or the owner (STEP S32). Also, in the OFF mode M4, the CPU performs a process of turning off the power of the sales data processing apparatus 30 (STEP S42).

However, in STEP S12, S22, S32, or S42, since the power of the communication unit is in the OFF state, the CPU does not perform output of a beacon for establishing communication with the communication unit, unlike in the case where the power of the communication unit is in the ON state.

[2-2. Description of Modes of Turning on Power of Communication Unit]

All of the registration mode M5, the adjustment mode M6, and the setting mode M7 are modes of turning on the power of the communication unit and performing wireless communication with a portable terminal 20.

Therefore, first, the CPU 31 performs a process of turning on the power of one of the narrow-area communication unit 38 and the wide-area communication unit 39. For example, in the registration mode M5, the CPU performs a process of turning on the power of the wide-area communication unit 39 while performing a process of turning off the power of the narrow-area communication unit 38 (STEP S51). Also, in the adjustment mode M6 and the setting mode M7, the CPU performs a process of turning on the power of the narrow-area communication unit 38 while performing a process of turning off the power of the wide-area communication unit 39 (STEP S61 or S71).

In the registration mode M5, in the case where the power of the wide-area communication unit 39 has been already turned on (the power of the narrow-area communication unit 38 has been already turned off), the CPU proceeds to the next step without performing anything in particular. Also, in the adjustment mode M6 and the setting mode M7, in the case where the power of the narrow-area communication unit 38 has been already turned on (the power of the wide-area communication unit 39 has been already turned off), the CPU proceeds to the next step without performing anything in particular.

Next, the CPU 31 switches the sales data processing apparatus to a state where the sales data processing apparatus can perform communication with an application installed in a portable terminal 20 while outputting a beacon for establishing communication with the communication unit whose power was turned on. For example, in the registration mode M5, while switches the sales data processing apparatus to a state where the sales data processing apparatus can perform communication with the order entry application installed in the portable terminal 20, the CPU outputs a beacon for establishing communication with the wide-area communication unit 39 whose power was turned on in STEP S51 (STEP S52). If the portable terminal 20 receives the beacon output in STEP S52, it establishes communication between the wide-area communication unit 29 and the wide-area communication unit 39 of the sales data processing apparatus 30 which is the beacon transmission source.

Also, in the adjustment mode M6, while switching the sales data processing apparatus to a state where the sales data processing apparatus can perform communication with the adjustment application installed in a portable terminal 20, the CPU outputs a beacon for establishing communication with the narrow-area communication unit 38 whose power was turned on in STEP S61 (STEP S62). Also, in the setting mode M7, while switching the sales data processing apparatus to a state where the sales data processing apparatus can perform communication with the setting application installed in a portable terminal 20, the CPU outputs a beacon for establishing communication with the narrow-area communication unit 38 whose power was turned on in STEP S71 (STEP S72). If the portable terminal 20 receives the beacon output in STEP S62 or STEP S72, it establishes communication between the narrow-area communication unit 28 and the narrow-area communication unit 38 of the sales data processing apparatus 30 which is the beacon transmission source.

Subsequently, the CPU 31 performs a process corresponding to each mode.

For example, in the registration mode M5, the CPU performs a registering process based on a registering-process-related request transmitted from the portable terminal 20 and a registering process based on a manual operation of the operator or the owner on the sales data processing apparatus 30, at the same time. In other words, in the case where of performing the registering process based on the request transmitted from the portable terminal 20 and the registration based on the manual option at the same time, the CPU performs the corresponding processes in a multitasking manner. Further, the registering-process-related request transmitted from the portable terminal 20 is order data transmitted to the sales data processing apparatus 30 after the order entry application was activated in the portable terminal 20 and the operator or the owner performed a registering process.

Also, in the adjustment mode M6, the CPU performs an adjusting process based on a manual operation of the owner on the sales data processing apparatus 30, and then transmits adjustment data to the adjustment application of the portable terminal 20 (STEP S63). The portable terminal 20 waits adjustment data reception until adjustment data is input.

Also, in the setting mode M7, the CPU performs one process of a setting process based on a setting-process-related request transmitted from the portable terminal 20 and a setting process based on a manual operation of the owner on the sales data processing apparatus 30 (STEP S73). In other words, in the case where the CPU has performed the registration based on the request transmitted from the portable terminal 20 and the registration based on the manual operation at the same time, the CPU performs the process based on the setting-process-related request or the manual operation received first. Also, the setting-process-related request transmitted from the portable terminal 20 is setting data transmitted to the sales data processing apparatus 30 after the setting application was activated in the portable terminal 20 and the owner performed a setting process.

[3. Effects]

As described above, according to the electronic apparatus (the sales data processing apparatus 30) of the sales data processing system 1 of the present embodiment, the mode switching unit (the mode switch 42) for switching the electronic apparatus to a mode corresponding to a rotation position of an inserted key (a mode key K1) has the plurality of first rotation positions for switching the electronic apparatus to the first mode (the registration mode M5, the adjustment mode M6, and the setting mode M7) of performing switching to the state where the communication unit (the narrow-area communication unit 38 and the wide-area communication unit 39) can perform communication with a portable terminal 20, and at least one second rotation position for switching the electronic apparatus to a second mode (the check mode M1, the return mode M2, the calculator mode M3, and the OFF mode M4) of performing switching to the state where the communication unit cannot perform communication with any portable terminal 20, and the second rotation position is set so as not to be interposed between the first rotation positions.

Therefore, according to the electronic apparatus of the present embodiment, since it is possible to perform mode switching operations without unnecessarily turning on and off the power of the communication unit, it becomes possible to streamline processes during mode switching, so it is possible to reduce the power consumption.

Also, according to the electronic apparatus of the present embodiment, the mode switching unit is configured such that the keys can be inserted and then be rotated in ranges different depending on the types of the keys.

Therefore, according to the electronic apparatus of the present embodiment, it is possible to give the mode keys K1 according to the positions of people to operate the sales data processing apparatus 30 to them, thereby easily controlling the authority to operate the sales data processing apparatus 30. Therefore, it becomes possible to prevent the operator who is low in position from performing the highly-confidential modes (such as the adjustment mode M6 and the setting mode M7), so it is possible to safely operate the sales data processing apparatus 30.

Also, according to the electronic apparatus of the present embodiment, the mode switching unit has the plurality of third rotation positions for switching the electronic apparatus to the third mode (the adjustment mode M6 and the setting mode M7) of performing switching to the state where the narrow-area communication unit 38 can perform narrow-area wireless communication with a portable terminal 20, and has at least one fourth rotation position for switching the electronic apparatus to the fourth mode (the registration mode M5) of performing switching to the state where the wide-area communication unit 39 can perform wide-area wireless communication with the portable terminal 20, and the third rotation positions and the at least one fourth rotation position are arranged such that any third rotation position is not interposed between two fourth rotation position and any fourth rotation position is not interposed between two third rotation positions.

Therefore, according to the electronic apparatus of the present embodiment, since it is possible to perform mode switching operations without unnecessarily turning on and off the power of the narrow-area communication unit 38 or the wide-area communication unit 39, it becomes possible to further streamline processes during mode switching, so it is possible to further reduce the power consumption.

Although a detailed description has been made above on the basis of the embodiment according to the present disclosure, the present disclosure is not limited to the above-described embodiment, and can be modified without departing from the scope of the present disclosure.

For example, in the above-described embodiment, on the mode switch 42, the individual modes are arranged in the order of the check mode M1, the return mode M2, the calculator mode M3, the OFF mode M4, the registration mode M5, the adjustment mode M6, and the setting mode M7; however, the present disclosure is not limited thereto. For example, the check mode M1, the return mode M2, the calculator mode M3, and the OFF mode M4 in which wireless communication with the portable terminal 20 may be arranged in random order, or may be arranged in any other order. Also, the adjustment mode M6 and the setting mode M7 of performing the same wireless communication (narrow-area wireless communication) with a portable terminal 20 may be arranged in random order, or may be arranged in any other order.

Also, for example, the registration mode M5 of turning on the power of the wide-area communication unit 39 and performing wide-area wireless communication with the portable terminal 20 may be arranged after the adjustment mode M6 and the setting mode M7 of turning on the power of the narrow-area communication unit 38 and performing narrow-area wireless communication with a portable terminal 20.

Also, in the above-described embodiment, as examples of the first mode of performing switching to the state where the communication unit can perform communication with a portable terminal 20, three modes (the registration mode M5, the adjustment mode M6, and the setting mode M7) have been described, and as examples of the second mode of performing switching to the state where the communication unit cannot perform communication with any portable terminal 20, four modes (the check mode M1, the return mode M2, the calculator mode M3, and the OFF mode M4) have been described; however, the present disclosure is not limited thereto. Any other configuration may be used as long as the corresponding configuration has a plurality of modes as first mode and has at least one mode as a second mode.

Also, in the above-described embodiment, the portable terminal 20 and the sales data processing apparatus 30 perform two types of wireless communication, i.e. narrow-area wireless communication and wide-area wireless communication with each other; however, the present disclosure is not limited thereto. In other words, the present disclosure can be applied to a configuration capable of performing only one type of wireless communication.

Also, in the above-described embodiment, the operator key K11 can be used to perform switching to the calculator mode M3, the OFF mode M4, and the registration mode M5; however, the present disclosure is not limited thereto. For example, the operator key K11 may also be used to perform switching to the check mode M1. In this case, the check mode M1 may be arranged at a certain position adjacent to the calculator mode M3, the OFF mode M4, and the registration mode M5.

Also, a configuration which does not include the operator key K11 (in other words, a configuration including only the owner key K12) may be used. In this case, since the mode switch 42 does not need to be configured such that the rotatable ranges of the mode keys K1 are different depending on the types of the mode keys K1, manufacturing is easy.

Although some embodiments of the present disclosure have been described, the scope of the present disclosure is not limited to the above described embodiments, and includes the scopes of inventions disclosed in claims and the scopes of their equivalents.

What is claimed is:

1. An electronic apparatus comprising:
a communication unit configured to perform wireless communication with a portable terminal; and
a mode switching unit configured such that a key inserted into the mode switching unit is rotatable and configured to perform switching to a mode corresponding to a rotation position of the inserted key, wherein
the mode switching unit has;
a plurality of first rotation positions for performing switching to a first mode of performing switching to a state where the communication unit can perform communication with the portable terminal; and
at least one second rotation position for performing switching to a second mode of performing switching to a state where the communication unit cannot perform communication with the portable terminal, and
the second rotation position is not interposed between the first rotation positions.

2. The electronic apparatus according to claim 1, wherein:
the mode switching unit is configured such that different types of keys are insertable into the mode switching unit and rotatable in ranges different depending on the types of the keys.

3. The electronic apparatus according to claim 2, wherein:
the keys include:
an operator key for an operator; and
an owner key for an owner, and
the mode switching unit is configured such that a range in which the operator key is rotatable when it is inserted into the mode switching unit is smaller than a range in which the owner key is rotatable when it is inserted into the mode switching unit.

4. The electronic apparatus according to claim 1, wherein:
the communication unit includes:
a narrow-area communication unit configured to perform narrow-area wireless communication with the portable terminal; and
a wide-area communication unit configured to perform wide-area wireless communication with the portable terminal,
the mode switching unit has:
a plurality of third rotation positions for performing switching to a third mode of performing switching to a state where the narrow-area communication unit can perform narrow-area wireless communication with the portable terminal; and
at least one fourth rotation position for performing switching to a fourth mode of performing switching to a state where the wide-area communication unit can perform wide-area wireless communication with the portable terminal, and
the third rotation positions and the at least one fourth rotation position are arranged such that any third rotation position is not interposed between two fourth rotation positions and any fourth rotation position is not interposed between two third rotation positions.

5. The electronic apparatus according to claim 4, wherein:
the third mode includes an adjustment mode and a setting mode, and
the fourth mode includes a registration mode.

6. The electronic apparatus according to claim 1, wherein:
the first mode includes a registration mode, an adjustment mode, and a setting mode, and
the second modes include a check mode, a return mode, a calculator mode, and an OFF mode.

7. A sales data processing apparatus comprising:
a communication unit configured to perform wireless communication with a portable terminal; and
a mode switching unit configured such that a key inserted into the mode switching unit is rotatable and configured to perform switching to a mode corresponding to a rotation position of the inserted key, wherein
the mode switching unit has;
a plurality of first rotation positions for performing switching to a first mode of performing switching to a state where the communication unit can perform communication with the portable terminal; and
at least one second rotation position for performing switching to a second mode of performing switching to a state where the communication unit cannot perform communication with the portable terminal, and
the second rotation position is not interposed between the first rotation positions.

8. The sales data processing apparatus according to claim 7, wherein:
the mode switching unit is configured such that different types of keys are insertable into the mode switching unit and rotatable in ranges different depending on the types of the keys.

9. The sales data processing apparatus according to claim 8, wherein:
the keys include:
an operator key for an operator; and
an owner key for an owner, and
the mode switching unit is configured such that a range in which the operator key is rotatable when it is inserted into the mode switching unit is smaller than a range in which the owner key is rotatable when it is inserted into the mode switching unit.

10. The sales data processing apparatus according to claim 7, wherein:
the communication unit includes:
a narrow-area communication unit configured to perform narrow-area wireless communication with the portable terminal; and
a wide-area communication unit configured to perform wide-area wireless communication with the portable terminal,
the mode switching unit has:
a plurality of third rotation positions for performing switching to a third mode of performing switching to a state where the narrow-area communication unit can perform narrow-area wireless communication with the portable terminal; and
at least one fourth rotation position for performing switching to a fourth mode of performing switching to a state where the wide-area communication unit can perform wide-area wireless communication with the portable terminal, and
the third rotation positions and the at least one fourth rotation position are arranged such that any third rotation position is not interposed between two fourth rotation positions and any fourth rotation position is not interposed between two third rotation positions.

11. The sales data processing apparatus according to claim 10, wherein:
the third mode includes an adjustment mode and a setting mode, and
the fourth mode includes a registration mode.

12. The sales data processing apparatus according to claim 7, wherein:
the first mode includes a registration mode, an adjustment mode, and a setting mode, and
the second modes include a check mode, a return mode, a calculator mode, and an OFF mode.

13. A cash register comprising:
a communication unit configured to perform wireless communication with a portable terminal; and
a mode switch configured such that a key inserted into the mode switch is rotatable and configured to perform switching to a mode corresponding to a rotation position of the inserted key, wherein
the mode switch has;
a plurality of first rotation positions for performing switching to a first mode of performing switching to a state where the communication unit can perform communication with the portable terminal; and
at least one second rotation position for performing switching to a second mode of performing switching to a state where the communication unit cannot perform communication with the portable terminal, and
the second rotation position is not interposed between the first rotation positions.

14. The cash register according to claim 13, wherein:
the mode switch is configured such that different types of keys are insertable into the mode switch and rotatable in ranges different depending on the types of the keys.

15. The cash register according to claim 14, wherein:
the keys include:
an operator key for an operator; and
an owner key for an owner, and
the mode switch is configured such that a range in which the operator key is rotatable when it is inserted into the mode switch is smaller than a range in which the owner key is rotatable when it is inserted into the mode switch.

16. The cash register according to claim 13, wherein:
the communication unit includes:
a narrow-area communication unit configured to perform narrow-area wireless communication with the portable terminal; and
a wide-area communication unit configured to perform wide-area wireless communication with the portable terminal,
the mode switch has:
a plurality of third rotation positions for performing switching to a third mode of performing switching to a state where the narrow-area communication unit can perform narrow-area wireless communication with the portable terminal; and
at least one fourth rotation position for performing switching to a fourth mode of performing switching to a state where the wide-area communication unit can perform wide-area wireless communication with the portable terminal, and
the third rotation positions and the at least one fourth rotation position are arranged such that any third rotation position is not interposed between two fourth rotation positions and any fourth rotation position is not interposed between two third rotation positions.

17. The cash register according to claim 16, wherein:
the third mode includes an adjustment mode and a setting mode, and
the fourth mode includes a registration mode.

18. The cash register according to claim 13, wherein:
the first mode includes a registration mode, an adjustment mode, and a setting mode, and
the second modes include a check mode, a return mode, a calculator mode, and an OFF mode.
